(19) United States
(12) Patent Application Publication
(10) Pub. No.: US 2025/0328225 A1
(43) Pub. Date: Oct. 23, 2025

(54) SYSTEMS AND METHODS FOR ZOOM AND PAN TECHNIQUES FOR VISUALIZING ORDINAL AND TEMPORAL DATA

(71) Applicant: Capital One Services, LLC, McLean, VA (US)

(72) Inventor: Rajarajan PACKIANATHAN, Bangalore (IN)

(73) Assignee: Capital One Services, LLC, McLean, VA (US)

(21) Appl. No.: 18/751,016

(22) Filed: Jun. 21, 2024

(30) Foreign Application Priority Data
Apr. 20, 2024 (IN) 202441031537

(51) Int. Cl. G06F 3/04845; G06F 3/0485

(52) U.S. Cl. CPC G06F 3/04845; G06F 3/0485; G06F 2203/04806

(57) ABSTRACT

In some aspects, methods and systems are described for a zoom technique for displaying ordinal data in a data visualization. The system calculates a first domain for displaying first data in a first user interface, wherein the first domain is associated with a first scaling factor, wherein the first data comprises ranges of ordinal values. In response to detecting a scroll event, the system records a cursor position. Based on the scroll event, the system determines a second scaling factor and calculates a second domain based on the second scaling factor and the cursor position, wherein the second domain includes ordinal values selected from the first data. The system thus displays the second domain in the first user interface.

### CROSS-REFERENCE TO RELATED APPLICATIONS

This application claims the benefit of priority of Indian Provisional Patent No. 202441031537, filed Apr. 20, 2024. The content of the foregoing application is incorporated herein in its entirety by reference.

### SUMMARY

Methods and systems are described herein for novel uses and/or improvements to visualizing ordinal and temporal data. As one example, methods and systems are described herein for adjusting the display of ordinal and temporal data in a user interface.

Conventional approaches to data visualization are not readily adaptable to ordinal or temporal data, due to their non-quantitative values or special formatting. There is no established framework for displaying visualizations of such data without translations into a linear scale. Such data that cannot be easily translated into numerical values face particular challenges with regard to changing visualizations views, such as zooming and panning in a user interface. Whereas numerical values can be easily adjusted to suit a new display using a simple multiplicative computation, ordinal, temporal and categorical data cannot be immediately adapted to a changed visualization due to zooming or panning.

By contrast, systems and methods described herein calculate a first domain associated with a first visualization. The first domain includes selections of data and is described by a scaling factor and/or a center point. In response to a drag or scroll event, the system may adjust the scaling factor or the center point in proportion to a degree of movement. The system may then re-compute a second domain to be displayed in the new visualization, the second domain including a different selection of data. The second domain may be calculated based on the center point, the scaling factor, and the entirety of the data. These methods enable ordinal, temporal and categorical data for visualization display where they would otherwise be ineligible for zoom and pan operations.

In some aspects, methods and systems are described herein comprising determining a first domain for displaying first data in a first user interface, wherein the first domain is associated with a first scaling factor, wherein the first data comprises ranges of ordinal values; in response to detecting a scroll event, recording a cursor position; based on the scroll event, determining a second scaling factor; determining a second domain based on the second scaling factor and the cursor position, wherein the second domain includes ordinal values selected from the first data; and generating for display the second domain in the first user interface.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for generating a rendered scale window for displaying ordinal data in a data visualization, in accordance with one or more embodiments.

FIG. 2A shows a first domain of ordinal data in a data visualization, in accordance with one or more embodiments.

FIG. 2B shows a second domain of ordinal data in a data visualization, in accordance with one or more embodiments.

FIG. 3 shows illustrative components for a system for generating a rendered scale window for displaying ordinal data in a data visualization, in accordance with one or more embodiments.

FIG. 4 shows a flowchart of the steps involved in generating a rendered scale window for displaying ordinal data in a data visualization, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

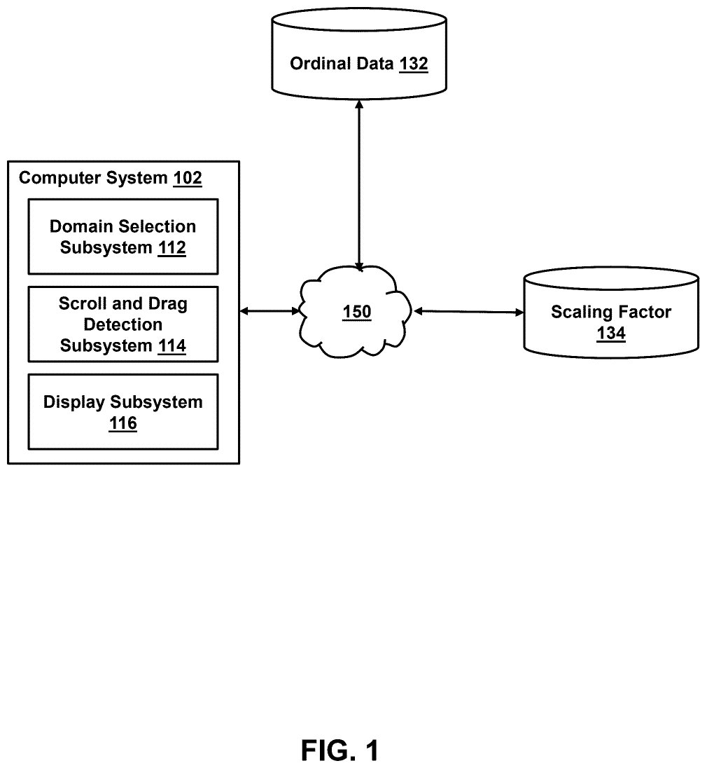

FIG. 1 shows an illustrative diagram for system 150 (the system), which contains hardware and software components used for generating a rendered scale window for displaying ordinal data in a data visualization, in accordance with one or more embodiments. For example, Computer System 102, a part of system 150, may include Domain Selection Subsystem 112, Scroll and Drag Detection Subsystem 114, and Display Subsystem 116. System 150 may create, store, or otherwise interact with Ordinal Data 132 and Scaling Factor 134.

The system may be deployed to display a set of ordinal data (e.g., Ordinal Data 132) in a user interface. For example, the system may create graphics such as scatter plots, box plots, and histograms in a user interface. Ordinal Data 132 consists of ordered, categorical, or temporal data which does not immediately translate into a real value. Rather, Ordinal Data 132 may represent a ranked order between values, for example indicating the first operation to perform in a sequence of steps, or the first-ranked option in a poll. As opposed to quantitative data, which is directly represented with real values, Ordinal Data 132 cannot use a notion of relative degree of difference. Quantitative data allows for easy comparison based on real-number computations, whereas ordinal data such as Ordinal Data 132 may only display a relative rank with no real-valued scale of absolute values. In addition to ordinal data, Ordinal Data 132 may, in some embodiments, include temporal or categorical data. Temporal data may include date-times and times such as “2015-03-07 12:32:17”, “17:01”, “2015-03-16”, “2015”, as well as timestamps encoded in alphanumerical formats such as “1552199579097”. Additionally or alternatively, Ordinal Data 132 may include categorical data, referring to data placed into categories or labels that have no correspondence real values. Categorical data may include, for example, image labels for an image classification dataset. Some images may be labeled “sedan” whereas others might be labeled “truck”.

Due to the nature of Ordinal Data 132, displaying such data in a user interface is challenged by the lack of a linear scale directly applicable to the data. Whereas numerical data can be easily displayed in a user interface by corresponding each pixel with a range of values of the data, ordinal, temporal and categorical data cannot correspond so simply to the axes of a user interface. Further, performing user operations like zooming and spanning to adjust the view displayed on the user interface is particularly difficult for such data due to the lack of a readily translatable linear scale. There's no readily available map from ordinal values, for example, to the pixels and screen locations on which to display such ordinal data. Instead, the systems and methods herein use domain selection in combination with scaling factors to determine what data is displayed. The system calculates a domain consisting of value ranges for one or more dimensions of data by applying a scaling factor to the data and selecting a range of values. The range of values may, for example, be initially centered on the mean values for the dimensions displayed. The range may encompass a portion of the data corresponding to the scaling factor. The system may thus determine which part of the data is to be displayed.

To display Ordinal Data 132 in a user interface view, the system (e.g., Domain Selection Subsystem 112) may calculate a first domain including a selection of ordinal data from Ordinal Data 132. For example, Domain Selection Subsystem 112 may select a range of ordinal values for a horizontal axis, and a range of ordinal values for the vertical axis. For example, Domain Selection Subsystem 112 may select cutoff values from Ordinal Data 132 based on Scaling Factor 134. Scaling Factor 134 is a value indicating the proportion of Ordinal Data 132 to be displayed in the first domain. The first domain may be associated with a first center point, the center point being associated with a value for the horizontal axis and a value for the vertical axis. The center point may be selected such that the mathematical average of the first domain corresponds to its values for the axes. The first domain may be associated with two values for the horizontal axis and two values for the vertical axis. In some embodiments, the user interface may display more than two dimensions of the data, and the first domain would therefore be selections from multiple features of data. The center point may also consist of more values than two. The system constructs a first domain by selecting a range of data corresponding to Scaling Factor 134. The range of data consists of a portion of Ordinal Data 132 specified by the scaling factor. For example, with a scaling factor of 2, the system may select half the data for a first feature and half the data for a second feature for display. The data ranges may be selected such that the center point values are at the mathematical middle points of each range.

The system may then display the first domain in the user interface by determining a length and width of the user interface. The length and width of the user interface may be measured in pixels, for example, and the system may allocate a number of pixels to each category of a categorical feature. The system may divide the number of pixels in the length by the number of categories in the first domain to determine a length allocation for each category. Similarly, the system divides the number of pixels in the width by the number of categories to derive a width allocation. The system subsequently causes to be displayed in the user interface all categories for the horizontal dimension according to width allocations, and the vertical dimension according to length allocations. Within each grid cell of length allocation and width allocation may be displayed the contents of Ordinal Data 132, for example feature values corresponding to the categories.

The system (e.g., Scroll and Drag Detection Subsystem 114) may detect a scroll event from one or more accessories to the computer system. For example, a user may interact with the user interface using a mouse. The user may input commands to the user interface, for example by adjusting the scroll wheel of the mouse. In some embodiments, the user may use other accessories or components of a computer system, such as making a finger gesture on a trackpad. Scroll and Drag Detection Subsystem 114 may detect a degree of movement, for example a degree of rotation on a scroll wheel. Scroll and Drag Detection Subsystem 114 may detect a scroll delta associated with the scroll event, the scroll delta indicating the extent of physical movement detected. The scroll delta may additionally be associated with a direction, which may be any combination of up, down, left, right, or diagonal movement. The system may store the scroll delta as, for example, a real-valued vector. Additionally or alternatively, the system may store a drag delta associated with a drag event. The drag event may be detected by, for example, a prolonged click combined with mouse movement. The system uses data from a computer accessory to determine the drag event.

Based on the scroll event, Scroll and Drag Detection Subsystem 114 determines a second scaling factor. For example, the system may apply a predetermined mathematical formula to the scroll delta to compute a scaling factor change (also known as a zoom factor). The system may detect the real-value distance of vertical movement for the scroll delta, and multiply the distance by a pre-set number to generate a scaling factor change. For example, the zoom factor may be a scroll delta multiplied by the number of pixels available on the display and then multiplied by −0.001. Thus, the scaling factor increases in response to a vertical movement of a scroll wheel. In some embodiments, scrolling in one direction causes a positive scaling factor change while scrolling in the other direction causes a negative scaling factor change. For example, a positive scroll delta leads to a decrease in scaling factor, and vice versa. The zoom factor computation includes multiplying by the pixel count of the display since doing so will expedite scrolling when the volume of domain data is large. The scaling factor change is a real number to be applied to the first scaling factor to generate the second scaling factor. In some embodiments, Scroll and Drag Detection Subsystem 114 instead detects a drag event, and determines a second center point based on the drag event. The drag event may be associated with a real-valued vector indicating the movement of the cursor in a horizontal direction and a vertical direction. The system may apply this vector to the position of the first center point and derive the position of a second center point, where the movement from the first center point to the second is identical to the real-valued vector of the drag event. In some embodiments, the system may detect a simultaneous drag event and scroll event. The system may thus determine a scaling factor change and re-calculate a center point for the second domain.

Domain Selection Subsystem 112 selects a second domain, based on the second scaling factor. For example, the system re-selects ranges of values for the horizontal axis and the vertical axis. The system may select a domain of a different size from the first domain. For example, the system may have changed the second scaling factor to be half as large as the first scaling factor. The system may correspondingly select more values centered on the center point. For example, whereas the first domain includes 2 values on each side of the center point, the second domain includes 4 values on each side of the center point. The system may process edge cases such as exceeding the maximum range of values by displaying, for example, the full range of values for the second domain when the second scaling factor reaches 1.

In some embodiments, Domain Selection Subsystem 112 selects the second domain based on the second center point. The center point may, for example, correspond to a cursor position at the time of a zoom event. The center point is such that during a zoom or a scroll operation, the number of data points modified with respect to the center point is the same for each direction. For example, if a zoom event were to cause a first domain of 6 horizontal values and 8 vertical values to lead to a second domain of 4 horizontal values and 6 vertical values, the second domain may be selected such that one value is removed to the left of the center point, and one value is removed to its right. Similarly, one value above the center point is removed, and so is one value below. For example, in these embodiments, the second domain following a drag operation may contain the same size of ranges in the horizontal and vertical axes. Whereas the horizontal axis may have displayed 6 values and the vertical axis 8 values in the first domain, the second domain may still display 6 values on the horizontal axis and 8 on the vertical. The system may, however, re-select values to display based on the center point. For example, the system may select 3 values immediately to the left and 3 values immediately to the right of the value of the center point on the horizontal axis. Similarly, the system selects the 8 values on the vertical axis centered precisely on the second center point.

Display Subsystem 116 displays the second domain in the user interface based on the second scaling factor or the second center point. The system may determine a correspondence from the second domain to the range of pixel values. For example, the system may divide the number of pixels equally among the number of features displayed for each dimension. In some embodiments, the system may have to adjust bandwidths for histograms or other parameters for other data visualizations to accommodate the updated pixel count.

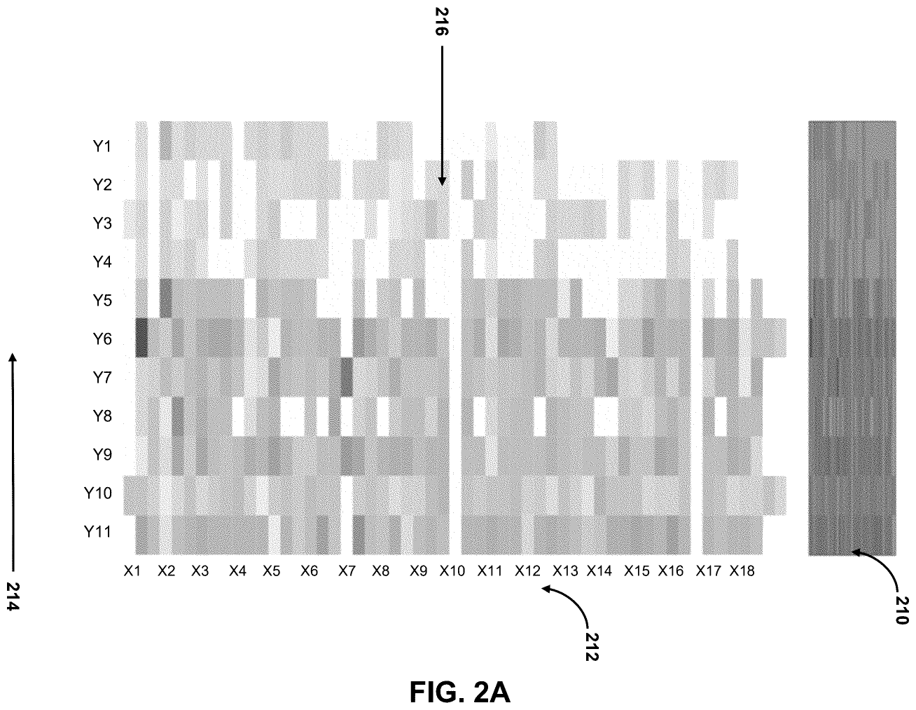

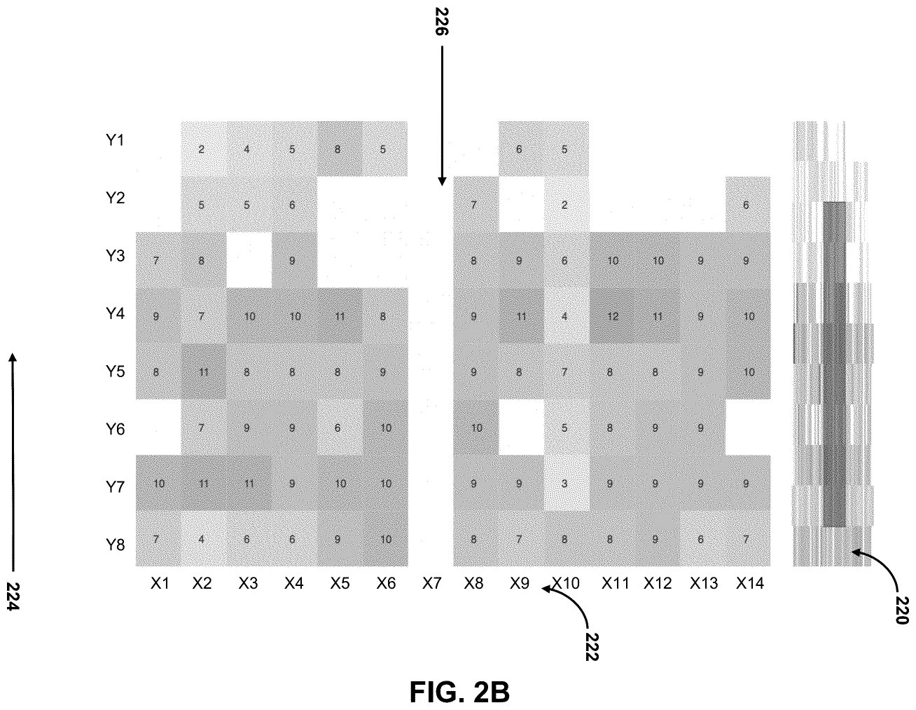

FIG. 2A demonstrates a first domain displayed on a user interface, showing two dimensions of categorical data. Displayed on the user interface is Selection 210, indicating the part of the first data included in this current view (the first domain). For FIG. 2A, the entirety of the first data is included and thus Selection 210 is entirely shaded over. On the main display of the data itself in the center of the user interface, the system indicates a Dimension 212 and a Dimension 214. In this case, both dimensions are categorical data, composed of different classes with no easy real-value representation. The first data may be arranged such that each category may be associated with a frequency count. Additionally, the frequency of a category can be further divided according to a secondary category in a different dimension. For example, while the category “Y1” in Dimension 214 may be associated with a total frequency, that total frequency may be broken down to values for “Y1” and “X8” in Dimension 212, a separate value for “Y1” and “X7” in Dimension 212, and so on. The system may display these composite frequency values in a grid format (Visualization 216), due to both dimensions being categorical in nature. In some embodiments, the system may display a heat map in this grid format in cases where digits are too small for display. In another example, one of the dimensions being displayed may be categorical while another may be numeric, in a histogram or some equivalent visualization.

In Visualization 216, the first domain contains the entirety of the data, and the available space for display is therefore divided equally among each category in each dimension. The large number of categories in Dimension 212 result in a rectangular shape for each cell in the visualization grid with the short side on Dimension 212. The system may split the number of pixels across the number of dimensions for both Dimension 212 and Dimension 214, resulting in distinct cells of the grid. In other data formats, for example temporal data, the heat map may have less strictly delineated boundaries and may resemble a diffusive diagram.

FIG. 2B demonstrates a second domain displayed on a user interface, showing two dimensions of categorical data. For example, the second domain may result from a zoom operation from the first domain. For example, the system may detect a zoom delta and calculate a scaling factor change associated with the delta. For example, the system may double the scaling factor from 1 in Visualization 216 to 2 in Visualization 226. Consequently, Selection 220 will also show only a portion of the data as contained in the second domain. The shaded region may correspond to the data displayed, to present the user with a view of the scale and relative location of the visualization within the data. Dimension 222 and Dimension 224 are still the same categories in the data, but due to the scaling factor change now contain different selections of categories. For example, there are fewer categories displayed in Dimension 222 compared to Dimension 212. Those left remaining may be the selected half of categories in the center of Dimension 212. Dimension 224 may contain similarly selected categories from Dimension 214. Due to the reduced nature of the second dimension, Visualization 226 assigns more space to each cell in the grid. The same number of pixels are now used to display less cells than in Visualization 216, and each cell correspondingly gets assigned more pixels. The result is that with each cell being larger, the frequencies for each displayed pair of categories (one category from Dimension 222 and one from Dimension 224) are shown in numerical format on Visualization 226 in addition to the heat map presentation of cells being shaded in proportion to frequency values.

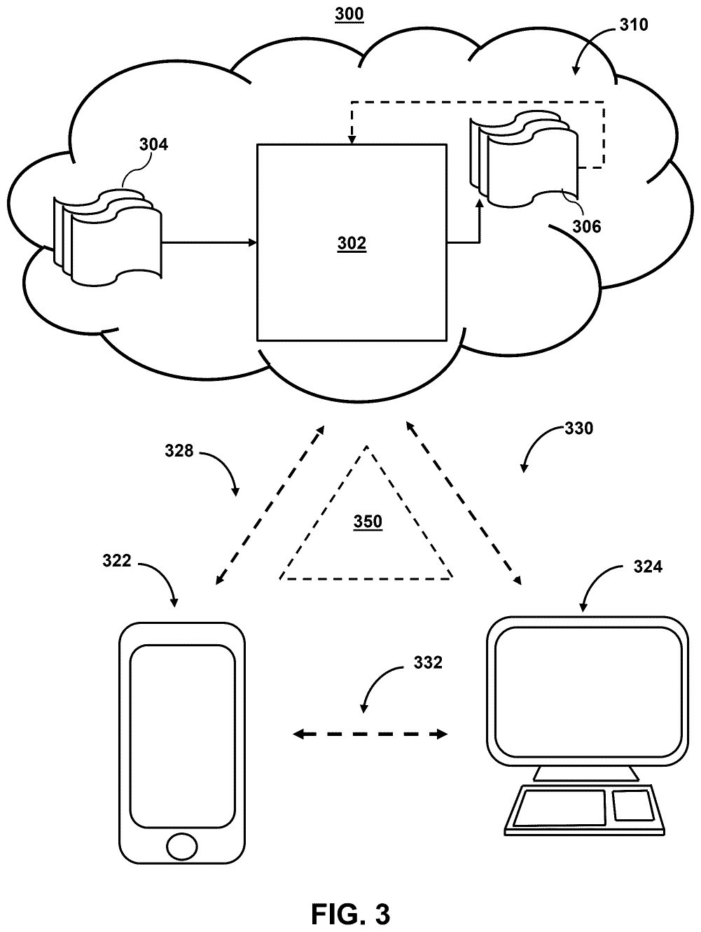

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., views for data visualization).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

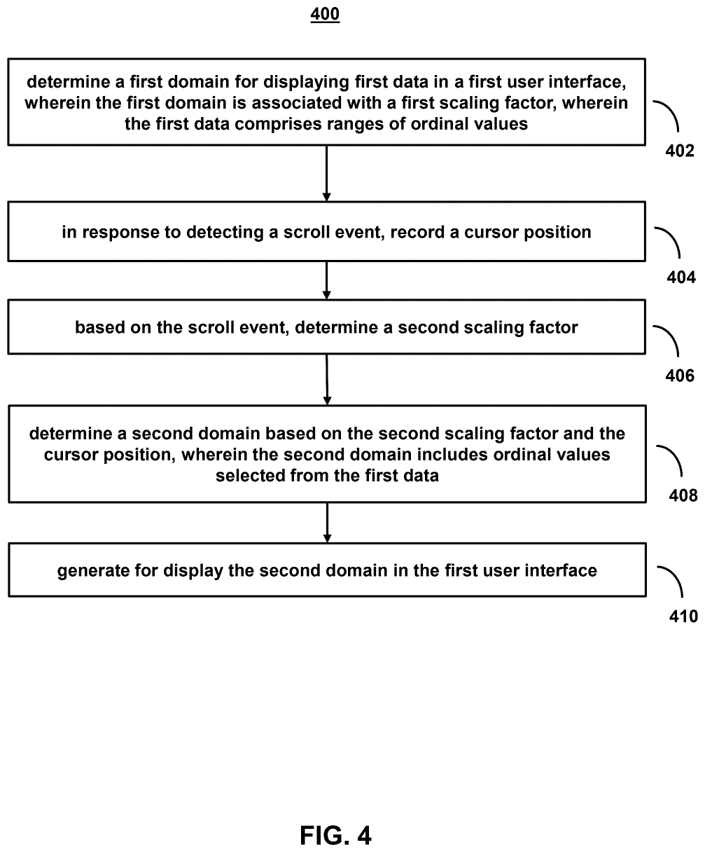

FIG. 4 shows a flowchart of the steps involved in generating a rendered scale window for displaying ordinal data in a data visualization, in accordance with one or more embodiments.

At step 402, process 400 (e.g., using one or more components described above) calculates a first domain for displaying first data in a first user interface, wherein the first domain is associated with a first scaling factor, wherein the first data comprises ranges of ordinal values. The system may be deployed to display a set of ordinal data (e.g., Ordinal Data 132) in a user interface. For example, the system may create graphics such as scatter plots, box plots, and histograms in a user interface. Ordinal Data 132 consists of ordered, categorical, or temporal data which does not immediately translate into a real value. Rather, Ordinal Data 132 may represent a ranked order between values, for example indicating the first operation to perform in a sequence of steps, or the first-ranked option in a poll. As opposed to quantitative data, which is directly represented with real values, Ordinal Data 132 cannot use a notion of relative degree of difference. Quantitative data allows for easy comparison based on real-number computations, whereas ordinal data such as Ordinal Data 132 may only display a relative rank with no real-valued scale of absolute values. In addition to ordinal data, Ordinal Data 132 may, in some embodiments, include temporal or categorical data. Temporal data may include date-times and times such as “2015-03-07 12:32:17”, “17:01”, “2015-03-16”, “2015”, as well as timestamps encoded in alphanumerical formats such as “1552199579097”. Additionally or alternatively, Ordinal Data 132 may include categorical data, referring to data placed into categories or labels that have no correspondence real values. Categorical data may include, for example, image labels for an image classification dataset. Some images may be labeled “sedan” whereas others might be labeled “truck”.

Due to the nature of Ordinal Data 132, displaying such data in a user interface is challenged by the lack of a linear scale directly applicable to the data. Whereas numerical data can be easily displayed in a user interface by corresponding each pixel with a range of values of the data, ordinal, temporal and categorical data cannot correspond so simply to the axes of a user interface. Further, performing user operations like zooming and spanning to adjust the view displayed on the user interface is particularly difficult for such data due to the lack of a readily translatable linear scale. There's no readily available map from ordinal values, for example, to the pixels and screen locations on which to display such ordinal data. Instead, the systems and methods herein use domain selection in combination with scaling factors to determine what data is displayed. The system calculates a domain consisting of value ranges for one or more dimensions of data by applying a scaling factor to the data and selecting a range of values. The range of values may, for example, be initially centered on the mean values for the dimensions displayed. The range may encompass a portion of the data corresponding to the scaling factor. The system may thus determine which part of the data is to be displayed.

To display Ordinal Data 132 in a user interface view, the system (e.g., Domain Selection Subsystem 112) may calculate a first domain including a selection of ordinal data from Ordinal Data 132. For example, Domain Selection Subsystem 112 may select a range of ordinal values for a horizontal axis, and a range of ordinal values for the vertical axis. For example, Domain Selection Subsystem 112 may select cutoff values from Ordinal Data 132 based on Scaling Factor 134. Scaling Factor 134 is a value indicating the proportion of Ordinal Data 132 to be displayed in the first domain. The first domain may be associated with a first center point, the center point being associated with a value for the horizontal axis and a value for the vertical axis. The center point may be selected such that the mathematical average of the first domain corresponds to its values for the axes. The first domain may be associated with two values for the horizontal axis and two values for the vertical axis. In some embodiments, the user interface may display more than two dimensions of the data, and the first domain would therefore be selections from multiple features of data. The center point may also consist of more values than two. The system constructs a first domain by selecting a range of data corresponding to Scaling Factor 134. The range of data consists of a portion of Ordinal Data 132 specified by the scaling factor. For example, with a scaling factor of 0.5, the system may select half the data for a first feature and half the data for a second feature for display. The data ranges may be selected such that the center point values are at the mathematical middle points of each range.

The system may then display the first domain in the user interface by determining a length and width of the user interface. The length and width of the user interface may be measured in pixels, for example, and the system may allocate a number of pixels to each category of a categorical feature. The system may divide the number of pixels in the length by the number of categories in the first domain to determine a length allocation for each category. Similarly, the system divides the number of pixels in the width by the number of categories to derive a width allocation. The system subsequently causes to be displayed in the user interface all categories for the horizontal dimension according to width allocations, and the vertical dimension according to length allocations. Within each grid cell of length allocation and width allocation may be displayed the contents of Ordinal Data 132, for example feature values corresponding to the categories.

At step 404, process 400 (e.g., using one or more components described above) records a cursor position in response to detecting a scroll event. The system (e.g., Scroll and Drag Detection Subsystem 114) may detect a scroll event from one or more accessories to the computer system. For example, a user may interact with the user interface using a mouse. The user may input commands to the user interface, for example by adjusting the scroll wheel of the mouse. In some embodiments, the user may use other accessories or components of a computer system, such as making a finger gesture on a trackpad. Scroll and Drag Detection Subsystem 114 may detect a degree of movement, for example a degree of rotation on a scroll wheel. Scroll and Drag Detection Subsystem 114 may detect a scroll delta associated with the scroll event, the scroll delta indicating the extent of physical movement detected. The scroll delta may additionally be associated with a direction, which may be any combination of up, down, left, right, or diagonal movement. The system may store the scroll delta as, for example, a real-valued vector. Additionally or alternatively, the system may store a drag delta associated with a drag event. The drag event may be detected by, for example, a prolonged click combined with mouse movement. The system uses data from a computer accessory to determine the drag event.

At step 406, process 400 (e.g., using one or more components described above) determine a second scaling factor based on the scroll event. Based on the scroll event, Scroll and Drag Detection Subsystem 114 determines a second scaling factor. For example, the system may apply a predetermined mathematical formula to the scroll delta to compute a scaling factor change. The system may detect the real-value distance of vertical movement for the scroll delta, and multiply the distance by a pre-set number to generate a scaling factor change. In some embodiments, scrolling in one direction causes a positive scaling factor change while scrolling in the other direction causes a negative scaling factor change. For example, the zoom factor may be a scroll delta multiplied by the number of pixels available on the display and then multiplied by −0.001. Thus, the scaling factor increases in response to a vertical movement of a scroll wheel. The scaling factor change is a real number to be applied to the first scaling factor to generate the second scaling factor. In some embodiments, Scroll and Drag Detection Subsystem 114 instead detects a drag event, and determines a second center point based on the drag event. The drag event may be associated with a real-valued vector indicating the movement of the cursor in a horizontal direction and a vertical direction. The system may apply this vector to the position of the first center point and derive the position of a second center point, where the movement from the first center point to the second is identical to the real-valued vector of the drag event. In some embodiments, the system may detect a simultaneous drag event and scroll event. The system may thus determine a scaling factor change and re-calculate a center point for the second domain.

At step 408, process 400 (e.g., using one or more components described above) calculates a second domain based on the second scaling factor and the cursor position, wherein the second domain includes ordinal values selected from the first data. Domain Selection Subsystem 112 selects a second domain, based on the second scaling factor. For example, the system re-selects ranges of values for the horizontal axis and the vertical axis. The system may select a domain of a different size from the first domain. For example, the system may have changed the second scaling factor to be half as large as the first scaling factor. The system may correspondingly select more values centered on the center point. For example, whereas the first domain includes 2 values on each side of the center point, the second domain includes 4 values on each side of the center point. The system may process edge cases such as exceeding the maximum range of values by displaying, for example, the full range of values for the second domain when the second scaling factor reaches 1.

In some embodiments, Domain Selection Subsystem 112 selects the second domain based on the second center point. For example, in these embodiments, the second domain may contain the same size of ranges in the horizontal and vertical axes. Whereas the horizontal axis may have displayed 6 values and the vertical axis 8 values in the first domain, the second domain may still display 6 values on the horizontal axis and 8 on the vertical. The system may, however, re-select values to display based on the center point. For example, the system may select 3 values immediately to the left and 3 values immediately to the right of the value of the center point on the horizontal axis. Similarly, the system selects the 8 values on the vertical axis centered precisely on the second center point.

At step 410, process 400 (e.g., using one or more components described above) displays the second domain in the first user interface. Display Subsystem 116 displays the second domain in the user interface based on the second scaling factor or the second center point. The system may determine a correspondence from the second domain to the range of pixel values. For example, the system may divide the number of pixels equally among the number of features displayed for each dimension. In some embodiments, the system may have to adjust bandwidths for histograms or other parameters for other data visualizations to accommodate the updated pixel count.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for generating a rendered scale window for displaying ordinal data in a data visualization, comprising: selecting a horizontal dimension and a vertical dimension for displaying first data in a first user interface, wherein the horizontal dimension and the vertical dimension comprise two features in the first data, and wherein the first data comprises ranges of ordinal values; determining a first domain comprising a range of values in the horizontal dimension and the vertical dimension, wherein the first domain is associated with a first scaling factor, wherein the first scaling factor is a real value indicating a proportion of the first data contained in the first domain; in response to detecting a scroll event, recording a cursor position, wherein the cursor position corresponds to a location in the first user interface; based on the scroll event, determining a scaling factor change, wherein the scaling factor change is a real-valued derivative of a scroll delta associated with the scroll event; based on the scaling factor change, determining a second scaling factor; determining a second domain based on the second scaling factor, the first data, and the cursor position, wherein the second domain includes a different selection of ordinal values from the first data than the first domain; and generating for display the second domain in the first user interface by rendering a visualization of the horizontal dimension and the vertical dimension.
2. A method for a zoom technique for displaying ordinal data in a data visualization, comprising: determining a first domain for displaying first data in a first user interface, wherein the first domain is associated with a first scaling factor, wherein the first data comprises ranges of ordinal values; in response to detecting a scroll event, recording a cursor position; based on the scroll event, determining a second scaling factor; determining a second domain based on the second scaling factor and the cursor position, wherein the second domain includes ordinal values selected from the first data; and generating for display the second domain in the first user interface.
3. A method, comprising: determining a first domain for displaying first data in a first user interface, wherein the first data comprises ranges of ordinal values; in response to detecting a drag event, recording a first cursor position; based on the drag event, determining a cursor movement based on the first cursor position and a second cursor position; determining a second domain based on the first domain and the cursor movement, wherein the second domain includes ordinal values selected from the first data; and generating for display the second domain in the first user interface.
4. The method of any one of the preceding embodiments, wherein detecting a scroll event comprises detecting a degree of rotation from a computer accessory.
5. The method of any one of the preceding embodiments, wherein based on the scroll event, determining the second scaling factor: based on the degree of rotation, determining a multiplicative factor, wherein the multiplicative factor is a real value indicating a percentage of change from the first scaling factor to the second scaling factor; and based on the multiplicative factor and the first scaling factor, determining the second scaling factor.
6. The method of any one of the preceding embodiments, wherein determining the second domain comprises: determining a center point for the second domain based on the cursor position, wherein the center point is a set of ordinal value in the first data to be displayed in a middle of the first domain; based on the second scaling factor, determining a range of ordinal values, wherein the range of ordinal values is a proportion of the first data corresponding to the second scaling factor such that a center of the range of ordinal values is the center point; based on the first scaling factor and the second scaling factor, determining a unit size change, wherein the unit size change indicates a change to a bin width of histograms, a dot size for scatterplots, and a line thickness for linear graphs; and generating the second domain to include the range of ordinal values and the unit size change.
7. The method of any one of the preceding embodiments, further comprising recording a cursor position and determining the second domain based on detecting a drag event.
8. The method of any one of the preceding embodiments, wherein detecting the drag event comprises detecting a degree of movement from a computer accessory.
9. The method of any one of the preceding embodiments, wherein the degree of movement comprises a horizontal movement and a vertical movement based on distances between the cursor position and a second cursor position.
10. The method of any one of the preceding embodiments, wherein the first domain is associated with a first center point comprising a set of ordinal values in the first data, wherein the first domain displays a selection of the first data centered on the first center point, and wherein the first center point is used to display the first domain in the first user interface.
11. The method of any one of the preceding embodiments, wherein determining the second domain based on the first domain comprises: determining a second center point based on the first center point and the degree of movement; and determining the second domain to comprise a range of values selected from the first data, wherein the second domain contains a same number of data points as the first domain, and wherein the second domain is centered on the second center point.
12. The method of any one of the preceding embodiments, wherein determining the first domain comprises: determining a center point for the first domain based on the cursor position, wherein the center point is a set of ordinal value in the first data to be displayed in a middle of the first domain; based on the first scaling factor, determining a range of ordinal values, wherein the range of ordinal values is a proportion of the first data corresponding to the first scaling factor such that a center of the range of ordinal values is the center point; and generating the first domain to include the range of ordinal values.
13. One or more non-transitory computer-readable media storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for generating a rendered scale window for displaying ordinal data in a data visualization, the system comprising:
one or more processors; and
one or more non-transitory, computer-readable media comprising instructions that, when executed by the one or more processors, cause operations comprising:
selecting a horizontal dimension and a vertical dimension for displaying first data in a first user interface, wherein the horizontal dimension and the vertical dimension comprise two features in the first data, and wherein the first data comprises ranges of ordinal values;
determining a first domain comprising a range of values in the horizontal dimension and the vertical dimension, wherein the first domain is associated with a first scaling factor, wherein the first scaling factor is a real value indicating a proportion of the first data contained in the first domain;
in response to detecting a scroll event, recording a cursor position, wherein the cursor position corresponds to a location in the first user interface;
based on the scroll event, determining a scaling factor change, wherein the scaling factor change is a real-valued derivative of a scroll delta associated with the scroll event;
based on the scaling factor change, determining a second scaling factor;
determining a second domain based on the second scaling factor, the first data, and the cursor position, wherein the second domain includes a different selection of ordinal values from the first data than the first domain; and
generating for display the second domain in the first user interface by rendering a visualization of the horizontal dimension and the vertical dimension.

2. A method for a zoom technique for displaying ordinal data in a data visualization, comprising:
determining a first domain for displaying first data in a first user interface, wherein the first domain is associated with a first scaling factor, wherein the first data comprises ranges of ordinal values;
in response to detecting a scroll event, recording a cursor position;
based on the scroll event, determining a second scaling factor;
determining a second domain based on the second scaling factor and the cursor position, wherein the second domain includes ordinal values selected from the first data; and
generating for display the second domain in the first user interface.

3. The method of claim 2, wherein detecting a scroll event comprises detecting a degree of rotation from a computer accessory.

4. The method of claim 3, wherein based on the scroll event, determining the second scaling factor:
based on the degree of rotation, determining a multiplicative factor, wherein the multiplicative factor is a real value indicating a percentage of change from the first scaling factor to the second scaling factor; and
based on the multiplicative factor and the first scaling factor, determining the second scaling factor.

5. The method of claim 2, wherein determining the first domain comprises:
determining a center point for the first domain based on the cursor position, wherein the center point is a set of ordinal value in the first data to be displayed in a middle of the first domain;
based on the first scaling factor, determining a range of ordinal values, wherein the range of ordinal values is a proportion of the first data corresponding to the first scaling factor such that a center of the range of ordinal values is the center point; and
generating the first domain to include the range of ordinal values.

6. The method of claim 2, wherein determining the second domain comprises:
determining a center point for the second domain based on the cursor position, wherein the center point is a set of ordinal value in the first data to be displayed in a middle of the first domain;
based on the second scaling factor, determining a range of ordinal values, wherein the range of ordinal values is a proportion of the first data corresponding to the second scaling factor such that a center of the range of ordinal values is the center point;
based on the first scaling factor and the second scaling factor, determining a unit size change, wherein the unit size change indicates a change to a bin width of histograms, a dot size for scatterplots, and a line thickness for linear graphs; and
generating the second domain to include the range of ordinal values and the unit size change.

7. The method of claim 2, further comprising recording a cursor position and determining the second domain based on detecting a drag event.

8. The method of claim 7, wherein detecting the drag event comprises detecting a degree of movement from a computer accessory.

9. The method of claim 8, wherein the degree of movement comprises a horizontal movement and a vertical movement based on distances between the cursor position and a second cursor position.

10. The method of claim 8, wherein the first domain is associated with a first center point comprising a set of ordinal values in the first data, wherein the first domain displays a selection of the first data centered on the first center point, and wherein the first center point is used to display the first domain in the first user interface.

11. The method of claim 10, wherein determining the second domain based on the first domain comprises:
determining a second center point based on the first center point and the degree of movement; and
determining the second domain to comprise a range of values selected from the first data, wherein the second domain contains a same number of data points as the first domain, and wherein the second domain is centered on the second center point.

12. One or more non-transitory computer-readable media comprising instructions that, when executed by one or more processors, cause operations comprising:
determining a first domain for displaying first data in a first user interface, wherein the first data comprises ranges of ordinal values;
in response to detecting a drag event, recording a first cursor position;
based on the drag event, determining a cursor movement based on the first cursor position and a second cursor position;
determining a second domain based on the first domain and the cursor movement, wherein the second domain includes ordinal values selected from the first data; and
generating for display the second domain in the first user interface.

13. The one or more non-transitory computer-readable media of claim 12, further comprising altering a degree of zoom of the first user interface upon detecting a scroll event, comprising detecting a degree of rotation from a computer accessory.

14. The one or more non-transitory computer-readable media of claim 13, wherein determining the first domain comprises:
based on a first scaling factor, determining a range of ordinal values, wherein the first scaling factor is a real value corresponding to a proportion of the first data displayed in the first domain; and
generating the first domain to include the range of ordinal values.

15. The one or more non-transitory computer-readable media of claim 14, further comprising determining a second scaling factor based on the scroll event, comprising:
based on the degree of rotation, determining a multiplicative factor, wherein the multiplicative factor is a real value indicating a percentage of change from the first scaling factor to the second scaling factor; and
based on the multiplicative factor and the first scaling factor, determining the second scaling factor.

16. The one or more non-transitory computer-readable media of claim 15, wherein determining the second domain comprises:
determining a center point for the second domain based on the second cursor position, wherein the center point is a set of ordinal value in the first data to be displayed in a middle of the first domain;
based on the second scaling factor, determining a range of ordinal values, wherein the range of ordinal values is a proportion of the first data corresponding to the second scaling factor such that a center of the range of ordinal values is the center point;
based on the first scaling factor and the second scaling factor, determining a unit size change, wherein the unit size change indicates a change to a bin width of histograms, a dot size for scatterplots, and a line thickness for linear graphs; and
generating the second domain to include the range of ordinal values and the unit size change.

17. The one or more non-transitory computer-readable media of claim 12, wherein the operations further comprise recording a cursor position and determining the second domain based on detecting a drag event.

18. The one or more non-transitory computer-readable media of claim 17, wherein detecting the drag event comprises detecting a degree of movement from a computer accessory.

19. The one or more non-transitory computer-readable media of claim 18, wherein the degree of movement comprises a horizontal movement and a vertical movement based on distances between the cursor position and a second cursor position.

20. The one or more non-transitory computer-readable media of claim 18, wherein the first domain is associated with a first center point comprising a set of ordinal values in the first data, wherein the first domain displays a selection of the first data centered on the first center point, and wherein the first center point is used to display the first domain in the first user interface.
